(19) United States
(12) Patent Application Publication
(10) Pub. No.: US 2011/0228081 A1
(43) Pub. Date: Sep. 22, 2011

(54) VIDEO PROCESSING APPARATUS, VIDEO PROCESSING METHOD AND VIDEO IMAGING APPARATUS

(75) Inventor: Yoko MASUO, Iruma-shi (JP)

(73) Assignee: KABUSHIKI KAISHA TOSHIBA, Tokyo (JP)

(21) Appl. No.: 13/051,895

(22) Filed: Mar. 18, 2011

(30) Foreign Application Priority Data
Mar. 18, 2010 (JP) 2010-062984

(51) Int. Cl. H04N 7/18

(52) U.S. Cl. 348/135; 348/E07.085

(57) ABSTRACT

According to one embodiment, a video processing apparatus of a mobile object, includes: a receiver configured to receive video information from at least one of external video imaging apparatuses; a video information analyzer configured to obtain imaging position information and information with respect to an imaging angle and an imaging method from the received video information; a position measure configured to measure a present position and traveling direction of the mobile object; a video mapping determiner configured to determine a mapping format of a video, which is a displaying object of a display screen region in the received video information, based on outputs of the video information analyzer and the position measure; a video converter configured to correct and convert the received video based on the mapping format; and an output controller configured to output the corrected and converted video to a display device.

### CROSS REFERENCE TO RELATED APPLICATION(S)

The application is based upon and claims the benefit of priority from Japanese Patent Application No. 2010-062984 filed on Mar. 18, 2010, the entire contents of which are incorporated herein by reference.

### BACKGROUND

1. Field

The present invention relates to a video processing apparatus, a video processing method, and the like.

2. Description of the Related Art

In a conventional apparatus such as a portable navigation apparatus, information relating to a route to a destination or a traffic jam can be obtained in the form of a map or a video. However, such an apparatus cannot flexibly cope with a problem which daily confronts the user, such as that the front of a traffic jam or queue that currently occurs ahead of the user is to be checked.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is a block diagram showing the system configuration of a vehicle information processing apparatus which is an embodiment of the invention;

FIG. 2 is a block diagram showing the system configuration of a camera module having a Bluetooth function in the embodiment;

FIG. 3 is a functional diagram of the whole system of the embodiment;

FIG. 4 shows an example of the process flow of the embodiment;

FIGS. 5A and 5B show an example of a usage scene in the embodiment;

FIG. 6 is a block diagram showing the system configuration of a portable telephone having a Bluetooth function in another embodiment; and

FIGS. 7A and 7B show an example of a usage scene in the other embodiment.

### DETAILED DESCRIPTION

The invention can be applied to whole video processing apparatuses which are to be mounted on a mobile object, such as a portable navigation system. Hereinafter, embodiments of the invention will be described.

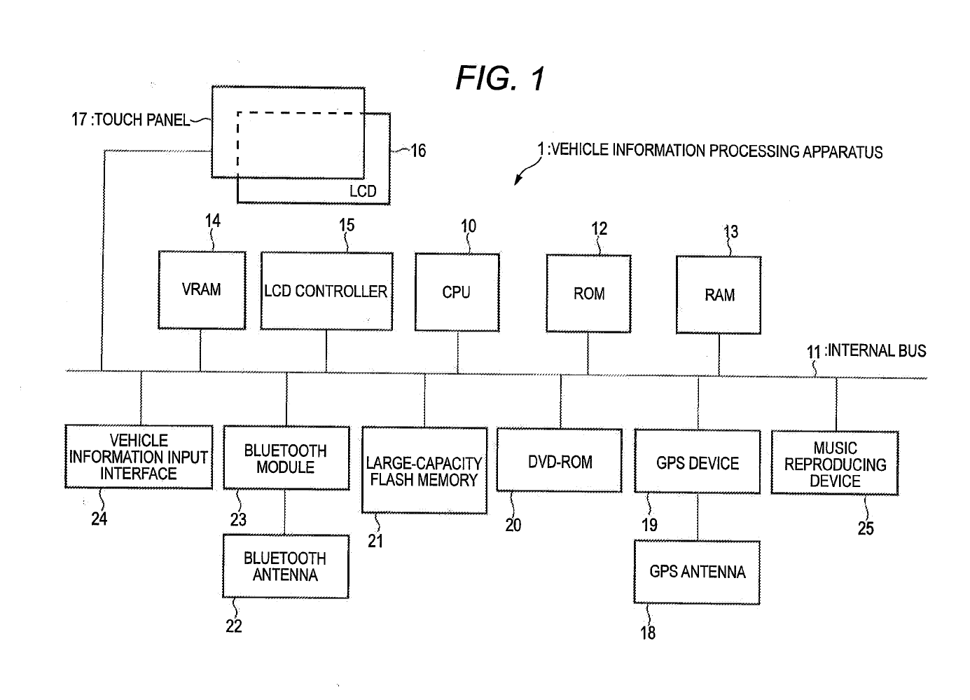

A first embodiment of the invention will be described with reference to FIGS. 1 to 5B.

FIG. 1 is a block diagram showing the system configuration of a vehicle information processing apparatus which is an embodiment of the invention.

As shown in FIG. 1, the vehicle information processing apparatus 1 of the embodiment is configured by a CPU 10, an internal bus 11, a ROM 12 which stores various programs, a RAM 13, a VRAM 14, an LCD controller 15, an LCD 16, a touch panel 17, a GPS antenna 18, a GPS device 19, a DVD-ROM 20 which stores music information, map information, and the like, a large-capacity flash memory (semiconductor disk) 21 which stores various information such as music information, a Bluetooth antenna 22, a Bluetooth module 23, a vehicle information input interface 24, and a music reproducing device 25. The apparatus has a Bluetooth function, and also functions of a vehicle navigation apparatus and an in-vehicle audio apparatus.

The CPU 10 is connected to various portions through the internal bus 11 to govern the control of the whole vehicle information processing apparatus 1, and executes the programs stored in the ROM 12, thereby realizing various functions such as a vehicle navigation apparatus and an in-vehicle audio apparatus.

The ROM 12 is a read-only memory device which is to store programs for operating the CPU 10, and various initial data, and stores programs for realizing various functions. In the embodiment, for example, programs for realizing a vehicle navigation apparatus and an in-vehicle audio apparatus, those for wireless communicating with other electronic apparatuses, and the like.

The RAM 13 is a memory device which is rewritable by the CPU 10, and used as a work area for temporarily storing various data. For example, the RAM temporarily stores data which are received through the Bluetooth module 23, those which are input through the vehicle information input interface 24, etc.

Under control of the CPU 10, the LCD controller 15 performs a display control for displaying various information such as information written into the VRAM 14, map information of a vehicle navigation apparatus or the like, and music piece titles and status information in an in-vehicle audio apparatus, on the LCD 16.

The LCD 16 is configured by, for example, a color display panel, and displays various information under control of the LCD controller 15.

The touch panel 17 is disposed in front of the LCD 16, and used for inputting data by touching one of selection items and instruction items displayed on the LCD 16 in a vehicle navigation apparatus, in-vehicle audio apparatus, or the like which is currently operating.

The GPS antenna 18 receives radio waves from GPS satellites, and supplies the received signals to the GPS device 19.

The GPS device 19 operates under control of the CPU 10, determines the present position of the vehicle on the basis of the GPS radio waves received through the GPS antenna 18, reads out map information stored in the DVD-ROM 20 based on the present position, and displays the present position on the LCD 16 via the VRAM 14 and the LCD controller 15, thereby realizing the vehicle navigation function.

The DVD-ROM 20 is a large-capacity storage medium which stores map information, music information, and the like. The map information stored on the DVD-ROM 20 is used for vehicle navigation, and the music information is reproduced by the music reproducing device 25.

The large-capacity flash memory 21 is a large-capacity semiconductor memory which stores, for example, music information and the like.

The Bluetooth antenna 22 is used for performing wireless communication between the Bluetooth module 23 and various electronic apparatuses mounted on the vehicle.

The Bluetooth module 23 controls wireless signals which are sent or received through the Bluetooth antenna 22. The Bluetooth module 23 employs the Bluetooth protocol as the wireless communication system. Bluetooth is a standard for short range wireless communication, and used for realizing wireless communication with 100 m or less by using the ISM (Industrial Scientific Medical) band. In Bluetooth, the frequency hopping method is used as a spread spectrum technique, and information can be transmitted while setting a maximum of eight apparatuses as a link using time-division multiplexing.

The vehicle information input interface 24 monitors vehicle information detected by sensors, such as the travelling speed, and inputs the information into the system.

The music reproducing device 25 has a music reproduction function such as MP3, and reproduces music data stored in the DVD-ROM 20 or the large-capacity flash memory 21, thereby realizing an in-vehicle audio apparatus.

In the thus configured vehicle information processing apparatus 1, an initial menu of the vehicle navigation function, the in-vehicle audio function, a function of communication with another electronic apparatus, and the like is displayed on the LCD 16. The driver of the vehicle touches an arbitrary function in the displayed menu to select the function. Thereafter, a menu or the like according to the selected function is displayed, and the function operates in accordance with an operation on the menu.

In accordance with the selected menu, the vehicle information processing apparatus 1 exchanges various information such as sounds, images, and computer program data with electronic apparatuses in and out the vehicle such as a portable telephone or camera module having a Bluetooth function, through the Bluetooth function.

Next, the system configuration of a camera module which is an electronic apparatus having a Bluetooth function will be described.

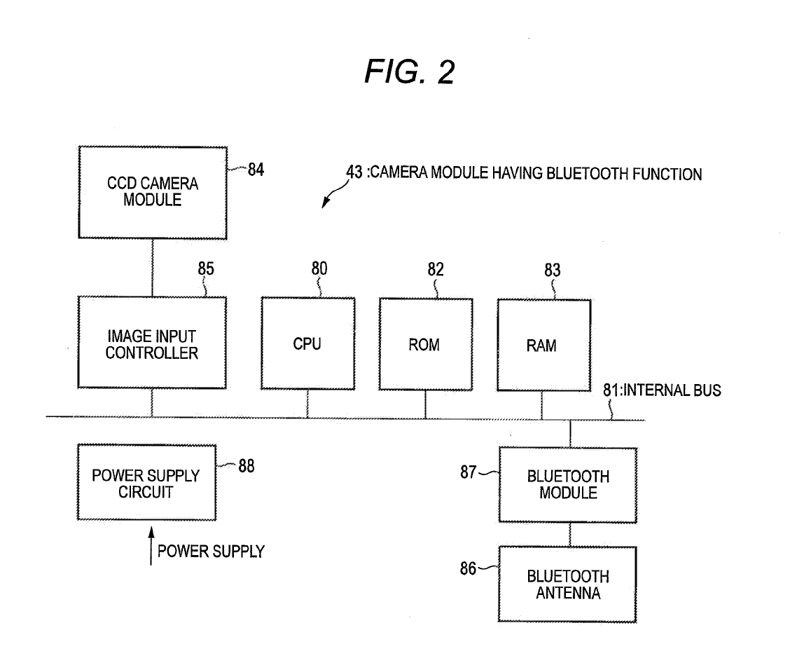

FIG. 2 is a block diagram showing the system configuration of a camera module 43 having a Bluetooth function.

As shown in FIG. 2, the camera module 43 in the embodiment is configured by a CPU 80, an internal bus 81, a ROM 82 which stores various programs, a RAM 83, a CCD camera module 84, an image input controller 85, a Bluetooth antenna 86, a Bluetooth module 87, and a power supply circuit 88.

The CPU 80 is connected to various portions through the internal bus 81 to govern the control of the whole camera module 43, and executes the programs stored in the ROM 82, thereby realizing various functions such as an image input function performed by the CCD camera module 84 and the image input controller 85, and a short range communication function performed by the Bluetooth antenna 86 and the Bluetooth module 87.

The ROM 82 is a read-only memory device which is to store programs for operating the CPU 80, and various initial data, and stores programs for realizing various functions.

The RAM 83 is a memory device which is rewritable by the CPU 80, and temporarily stores image data supplied from the CCD camera module 84, and the like.

The CCD camera module 84 takes an image of the rear of the vehicle, and supplies the image to the image input controller 85.

The image input controller 85 controls the input of the image which is taken by the CCD camera module 84.

The power supply circuit 88 produces operation voltages which are suitable for respective circuit portions, from a voltage supplied from a battery of the vehicle, performs a stabilizing process on the voltages, and supplies the stabilized voltages to the respective circuit portions.

In the configuration, images of the front and rear of the vehicle which are taken by the CCD camera module 84 are temporarily stored into the RAM 83 through the image input controller 85. Under control of the CPU 80, the images which are temporarily stored in the RAM 83 are sent to the vehicle information processing apparatus 1 through the Bluetooth module 87 and the Bluetooth antenna 86.

The vehicle information processing apparatus 1 causes the image information sent from the camera module 43 to be displayed on the LCD 16 through the LCD controller 15.

As described above, the images of the front and rear of the vehicle which are taken by the camera module 43 are displayed on the LCD 16. As required, therefore, the driver of the vehicle can monitor the front and rear of the vehicle.

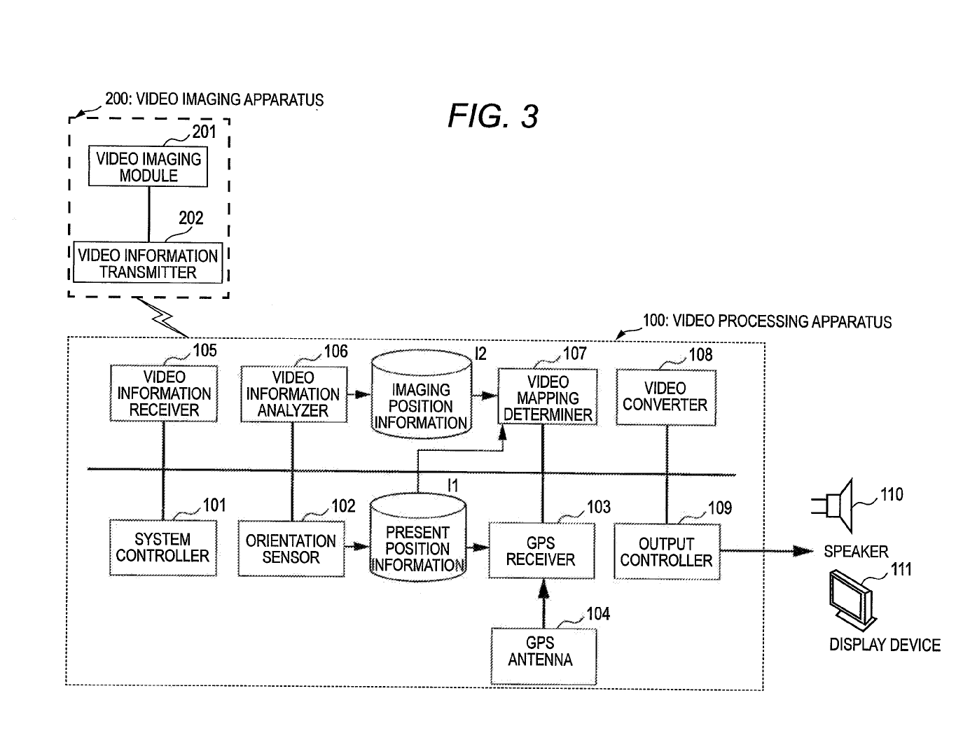

FIG. 3 is a functional diagram of the whole system of the embodiment.

In a video processing apparatus 100, present position information (I1) relating to the present position and travelling direction of the apparatus is obtained from the GPS (Global Positioning System) signal which is received by a GPS receiver 103 through a GPS antenna 104, an orientation sensor 102, and the like. When a navigation system is to be realized, for example, the present position information, and map information stored on a recording medium such as an HDD (not shown) are transferred to an output controller 109, announcement of the present information, and guidance of a route to the destination are performed by display on a display device 111, or an audio output from a speaker 110. The operations of the processing portions are generally controlled by a system controller 101. A conventional video processing apparatus is usually configured as described above.

By contrast, the embodiment is characterized to include a video information receiver 105, a video information analyzer 106, a video mapping determiner 107, and a video converter 108.

In the video processing apparatus 100 of the embodiment, one or plural sets of video information transmitted from a video imaging apparatus 200 are received by the video information receiver 105, and the video information analyzer 106 divides each set of information into the video body and imaging position information (I2) relating to the imaging position, the imaging angle, the imaging method, and the like. The imaging position information (I2) is transferred together with the present position information (I1) to the video mapping determiner 107. In the video mapping determiner 107, on the basis of these sets of position information, the video which is in the received video, and which is to be displayed, and the manner of mapping the video in the display screen region are determined. In accordance with the determined mapping format, the received video is converted in the video converter 108, and a video having more excellent visibility is output from the output controller 109.

The video imaging apparatus 200 includes a video imaging module 201 which takes a video containing information that enables the peripheral situation to be visible, and a video information transmitter 202 which transmits the taken video information to the video processing apparatus 100 located in the vicinity of the apparatus. In the video imaging module 201, a fish-eye camera is suitably used in order to take an image of a wider range by one shot. Alternatively, a camera of another type may be used.

The video processing apparatus 100 is the vehicle information processing apparatus 1, and the system controller 101, the video information analyzer 106, the video mapping determiner 107, and the video converter 108 correspond to the CPU 10, the ROM 12, and the RAM 13.

The GPS receiver 103 corresponds to the GPS device 19, and the GPS antenna 104 to the GPS antenna 18. Furthermore, the video information receiver 105 corresponds to the Bluetooth module 23, the Bluetooth antenna 22, and other devices.

A video related portion of the output controller 109 corresponds to the VRAM 14 and the LCD controller 15.

The video imaging apparatus 200 is the camera module 43, and the video imaging module 201 corresponds to the CCD camera module 84 and the image input controller 85. The video information transmitter 202 corresponds to the Bluetooth module 87, the Bluetooth antenna 86, and other devices.

According to the above-described configuration, in an individual mobile object, it is possible to easily realize production in which a video having excellent visibility is automatically produced in accordance with the position information, and an advantageous effect in which the user can use a UI that is more highly intuitive is obtained.

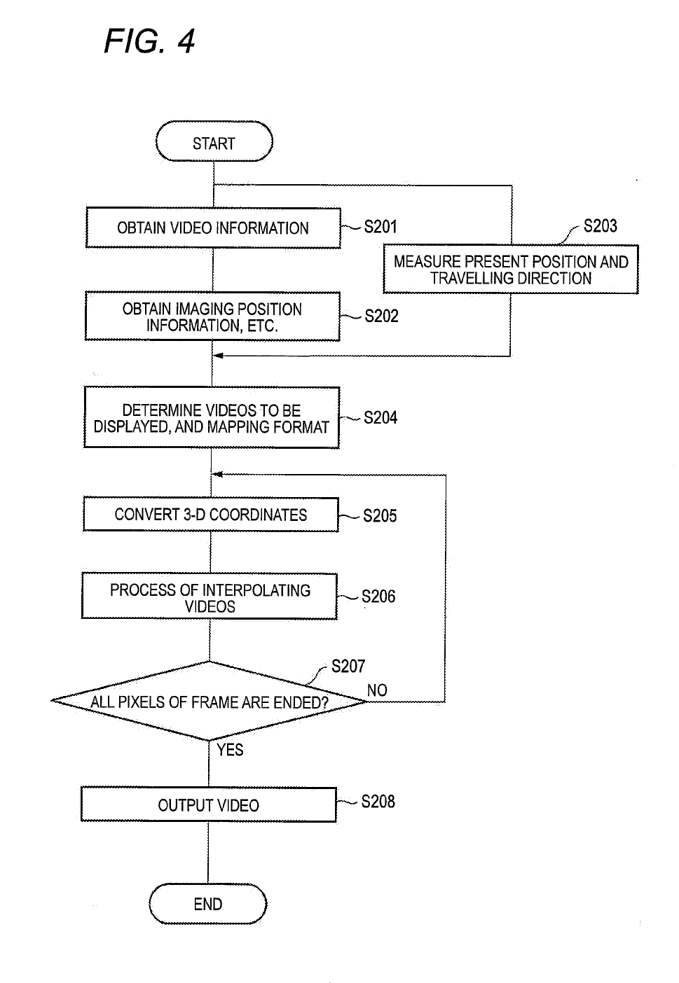

An example of the process flow in the invention will be described with reference to FIG. 4. Here, an example in which the received video is a wide-angle video taken by a fish-eye camera will be described.

Step S201: The video information receiver 105 obtains the video information taken by the video imaging apparatus 200. The video information includes the main content of a video, and also information relating to the imaging position, angle, method, and the like of the video. The method may be any one of various projection methods.

Step S202: In the video information analyzer (106), information of the imaging position, angle, method, and the like of the video is separated from the video information which is obtained in S201, and the separated information is held as the imaging position information (I2).

Step S203: Concurrently with S201 and S202, the present position and travelling direction of the mobile object itself are measured and held as the present position information (I1) by position measure such as the GPS (103, 104) and the like, and the orientation sensor 102.

Step S204: On the basis of various sets of information obtained in S202 and S203, the video mapping determiner 107 selects videos which are to be displayed. Parameters such as display regions and magnification factors of the videos, the manner of mapping on the display frame are determined so that the videos are joined to one another in the direction from the present position toward the travelling direction.

Step S205: A process of converting the obtained wide-angle video to a normal planar image is performed in the video converter 108. First, a corresponding position (x, y) of the wide-angle video is calculated with respect to the display frame coordinates (u, v).

Step S206: Next, the brightness of expanded or contracted (x, y) coordinates, i.e., the corresponding (u, v) coordinates is calculated by using bilinear interpolation, bicubic spline interpolation, or the like. In the case where there are videos in which the imaging angle and direction overlap within a specific threshold, transparency processing may be performed on a video which is close to the present position. In the transparency processing, a process of making the video translucent, or adding a pale color to the video may be performed.

Step S207: The above-described steps S205 and S206 are repeatedly performed on all pixels of the display frame. The technique of converting a wide-angle video to a normal planar image has been known.

Step S208: After the process for one frame is completed, the corrected and converted video is output to the display device 111 and the like through the output controller 109.

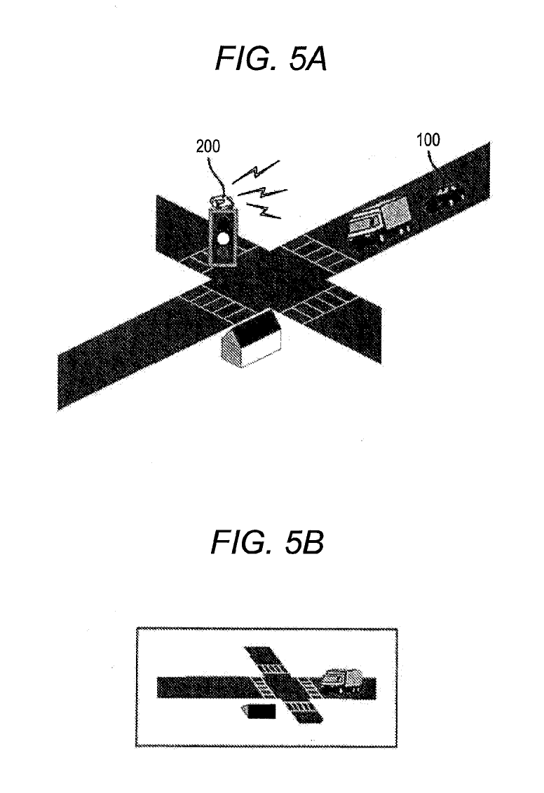

FIGS. 5A and 5B show an example of a usage scene in the embodiment.

FIGS. 5A and 5B show an example in which the vehicle information processing apparatus is used during driving of a vehicle. A large vehicle travels in front of the vehicle to block the driver's view. In the vehicle information processing apparatus 1 of the embodiment, as shown in FIG. 5A, two videos in front and rear of the vehicle which are taken from the upper side of an intersection by the camera module 43 that is disposed on a traffic light apparatus are used, and, as shown in FIG. 5B, the videos are compositely displayed at a distance ratio of, for example, front:rear=3:1 in the direction from the front position of the vehicle toward the travelling direction. As a result, the user can easily check that a traffic jam does not particularly occur on the road in advance of the intersection.

A second embodiment of the invention will be described with reference to FIGS. 2 to 4 and 6 to 7B. Description of components which are common to first embodiment is omitted.

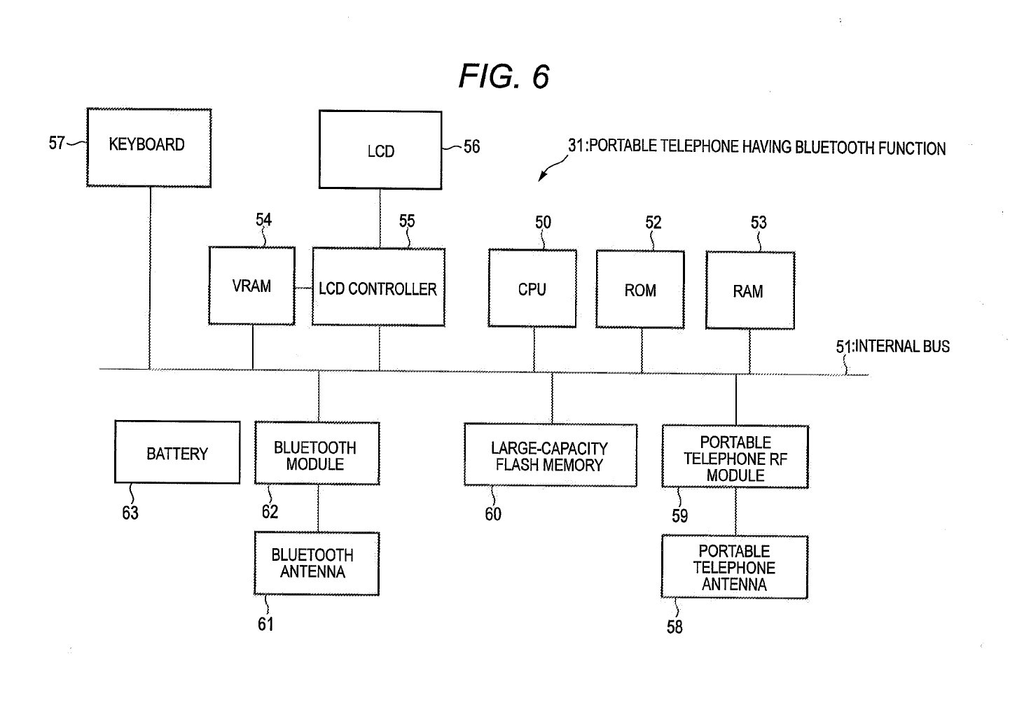

FIG. 6 is a block diagram showing the system configuration of a portable telephone 31 having a Bluetooth function.

As shown in FIG. 6, the portable telephone 31 of the embodiment is configured by a CPU 50, an internal bus 51, a ROM 52 which stores various programs, a RAM 53, a VRAM 54, an LCD controller 55, an LCD 56, a keyboard 57, a portable telephone antenna 58, a portable telephone RF module 59, a large-capacity flash memory (semiconductor disk) 60, a Bluetooth antenna 61, a Bluetooth module 62, and a battery 63.

The CPU 50 is connected to various portions through the internal bus 51 to govern the control of the whole portable telephone 31, and executes the programs stored in the ROM 52, thereby realizing various functions. Namely, the CPU 50 realizes a function of a portable telephone which uses the portable telephone antenna 58 and the portable telephone RF module 59, and a short range wireless communication function which uses the Bluetooth antenna 61 and the Bluetooth module 62.

The ROM 52 is a read-only memory device which is to store programs for operating the CPU 50, and various initial data, and stores programs for realizing various functions.

The RAM 53 is a memory device which is rewritable by the CPU 50, and temporarily stores work data in various processes, or various data received from other electronic apparatuses, and the like.

Under control of the CPU 50, the LCD controller 55 performs a display control for displaying various information written into the VRAM 54, such as information for notifying received data, on the LCD 56.

The LCD 56 displays various information under control of the LCD controller 55.

For example, the keyboard 57 includes ten keys functioning also as character input keys, and various function keys, and is used for inputting a telephone number or various control commands.

The portable telephone antenna 58 is an antenna for communicating with a base station for a portable telephone.

Under control of the CPU 50, the portable telephone RF module 59 performs a control for communicating with a base station through the portable telephone antenna 58, and has functions of detecting the electric field intensity in communication, or a change of the electric field intensity, and informing the CPU 50 of it.

The large-capacity flash memory 60 is a large-capacity semiconductor memory which stores various information.

The Bluetooth antenna 61 is used for performing short range wireless communication between the Bluetooth module 62 and the vehicle information processing apparatus 1 or other electronic apparatuses in and out the vehicle.

The Bluetooth module 62 controls wireless signals which are sent or received through the Bluetooth antenna 61, and has the same functions as those of the Bluetooth module 23 of the vehicle information processing apparatus 1.

The battery 63 is a secondary battery for accumulating an electric power for operating the portable telephone 31.

The portable telephone 31 has a portable telephone function performed by the portable telephone antenna 58 and the portable telephone RF module 59, and a short range wireless communication function performed by the Bluetooth antenna 61 and the Bluetooth module 62. The portable telephone further has portions (not shown) corresponding to the GPS device 19 and GPS antenna 18 shown in FIG. 1.

The video processing apparatus 100 is the portable telephone 31, and the system controller 101, the video information analyzer 106, the video mapping determiner 107, and the video converter 108 correspond to the CPU 50, the ROM 52, and the RAM 53.

Furthermore, the video information receiver 105 corresponds to the Bluetooth module 62, the Bluetooth antenna 61, and other devices.

A video related portion of the output controller 109 corresponds to the VRAM 54 and the LCD controller 55.

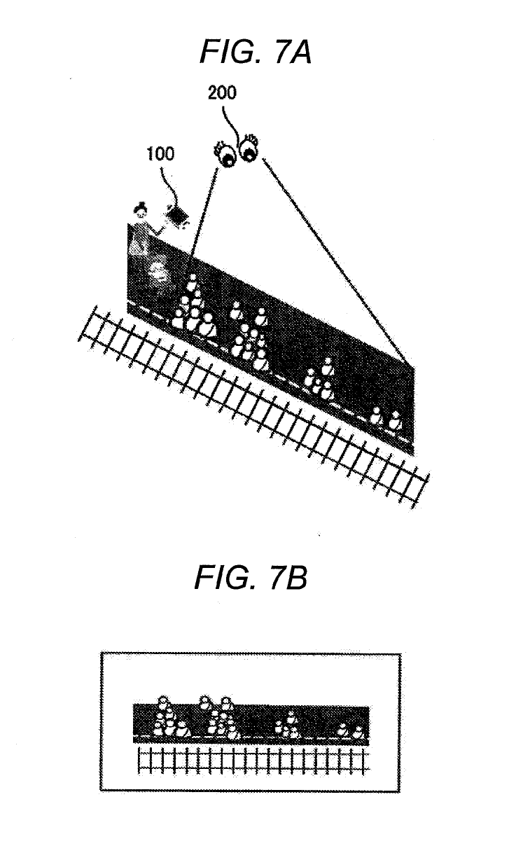

FIGS. 7A and 7B show an example of a usage scene in the embodiment.

FIGS. 7A and 7B show an example in which the portable telephone is used on a platform of a railway station. In the range which is visible from the front of the user, it seems that the whole area of the platform is crowded. In the portable telephone 31 of the embodiment, videos of a plurality of cameras which are disposed on the platform as shown in FIG. 7A are obtained, the videos are then combined with one another as shown in FIG. 7B, and the combined video is provided to the user. From the view from the upper side, the user can easily check a situation of “third car ahead is empty”.

Other embodiments and modifications of the invention will be described as follows.

According to the invention, received videos may be time sequentially stored in the video processing apparatus, and means for measuring the transition of the crowded status from a plurality of videos may be added. Reference information which is required for the user to determine the route can be automatically produced.

According to the invention, configurations for enabling the user to arbitrarily designate the display format in which the received video information is to be displayed may be added. For example, a plurality of videos may be combined into one video, or displayed on a multi-screen display device.

In a conventional portable navigation apparatus, information relating to a route to a destination or a traffic jam can be obtained in the form of a map or a video. However, such an apparatus cannot flexibly cope with a problem which daily confronts the user, such as that the front of a traffic jam or queue that currently occurs ahead of the user is to be checked.

In the above-described embodiments, the mapping format of a plurality of obtained images is determined in accordance with the present position and travelling direction of the mobile object itself, correction and conversion are performed, and then the images are displayed. From this viewpoint, it is possible to provide a UI that is more highly intuitive.

In the embodiment, in an individual mobile object, conversion and display of a video having excellent visibility are enabled on the basis of information of the position of the mobile object itself, and the imaging position. The above-described function is realized by providing a UI having augmented reality and more excellent intuition. In a site of an event such as an expo, or a specific facility such as an amusement park, the real time crowded statuses of a plurality of booths or attractions can be known at one time, and the user itself can determine a highly efficient route.

Furthermore, the invention may be employed also in checking what is in a crowd of people, or whether a queue in front of the user is directed to a booth, ticket-vending machine, or the like to which the user intends to go. For example, a system may be built in which a camera-equipped portable telephone of another person who is in a front part of the queue is caused to function as the video imaging apparatus 200, and the portable telephone of the user is caused to function as the video processing apparatus 100.

In the embodiment, as an effect of the above configuration, an apparatus in which, in an individual mobile object, a video taken by a camera can be displayed with being corrected and converted to a video having excellent visibility in accordance with position information of the mobile object can realized by an economic and simple configuration. It is possible to provide a UI that is more highly intuitive than the prior art, and it is expected to achieve an advantageous effect in which the convenience of the user is improved. The embodiments may have the following features.

The video processing apparatus of a mobile object may include: a receiver configured to receive video information from at least one of external video imaging apparatuses; a video information analyzer configured to obtain imaging position information and information with respect to an imaging angle and an imaging method from the received video information; a position measure configured to measure a present position and traveling direction of the mobile object; a video mapping determiner configured to determine a mapping format of a video, which is a displaying object of a display screen region in the received video information, based on outputs of the video information analyzer and the position measure; a video converter configured to correct and convert the received video based on the mapping format; and an output controller configured to output the corrected and converted video to a display device, thereby providing an intuitive UI in which the user can flexibly cope with a traffic jam or queue that currently occurs ahead of the user.

The video imaging apparatus may include an imaging module configured to take a video information with respect to a peripheral situation; and a transmitter configured to transmit the video information to the above video processing apparatus located in the vicinity of the video imaging apparatus.

The video information may contain a video which is taken by at least one of cameras, and which enables the peripheral situation to be visible, and position information of the imaging apparatus, and information relating to an imaging angle, an imaging method, and the like. Alternatively, additional information such as a waiting time may be contained.

A communicator between the video imaging apparatus and the video processing apparatus may be wireless or wired means, or has a structure where the both means are integrated with each other.

The embodiment does not require map information which has been described in the paragraph of Background Art, and has a high versatility because it can be used in a specific facility, map information of which is not provided.

The invention is not restricted to the above-described embodiments, and can be embodied while various modifications are made without departing the spirit of the invention. A communication system other than Bluetooth may be used. A camera-equipped portable telephone which is usually used is enabled to exert the function of the above-described camera module by program installation.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video processing apparatus, comprising:
a receiver configured to receive video information from at least one of a plurality of external video imaging apparatuses;
a video information analyzer configured to determine imaging position information, imaging angle information, and an imaging method associated with the video information;
a position measuring module configured to determine a present position;
a video mapping determiner configured to determine a mapping format of the video information to a display screen region, the mapping format based on the imaging position information, imaging angle information, imaging method associated with the video information, and the present position;
a video converter configured to convert the received video information for display based on the mapping format; and
an output controller configured to output the converted video to a display device.

2. The video processing apparatus of claim 1, wherein the video processing apparatus is located on a mobile device.

3. The video processing apparatus of claim 2, wherein the present position is of the mobile device.

4. The video processing apparatus of claim 3, wherein the position measuring module is further configured to determine the traveling direction of the mobile device.

5. A video imaging apparatus comprising:
an imaging module configured to acquire video information; and
a transmitter configured to transmit the video information to a video processing apparatus, the video processing apparatus comprising:
a receiver configured to receive video information from the video imaging apparatus;
a video information analyzer configured to determine at least one of imaging position information and imaging angle information;
a position measuring module configured to determine a present position;
a video mapping determiner configured to determine a mapping format of the video information to a display screen region, the mapping format based on the at least one of imaging position information and imaging angle information and the present position;
a video converter configured to convert the received video information for display based on the mapping format; and
an output controller configured to output the converted video to a display device.

6. The video imaging apparatus of claim 5, wherein the video processing apparatus is located on a mobile device.

7. The video imaging apparatus of claim 6, wherein the present position is of the mobile device.

8. The video imaging apparatus of claim 7, wherein the position measuring module is further configured to determine the traveling direction of the mobile device.

9. The video imaging apparatus of claim 5, wherein the video information analyzer is further configured to determine an imaging method associated with the video information.

10. The video imaging apparatus of claim 5, wherein the video processing apparatus is located in a vicinity of the video imaging apparatus.

11. A video processing apparatus comprising:
an imaging module configured to receive a video information;
a video information analyzer configured to determine imaging position information, imaging angle information, and an imaging method associated with the video information;
a position measuring module configured to determine a present position;
a video mapping determiner configured to determine a mapping format of the video information to a display screen region, the mapping format based on the imaging position information, imaging angle information, imaging method associated with the video information, and the present position;
a video converter configured to convert the received video information for display based on the mapping format; and
an output controller configured to output the converted video to a display device.

12. The video processing apparatus of claim 11, wherein the video processing apparatus is located on a mobile device.

13. The video processing apparatus of claim 12, wherein the present position is of the mobile device.

14. The video processing apparatus of claim 13, wherein the position measuring module is further configured to determine the traveling direction of the mobile device.

15. The video processing apparatus of claim 11, wherein the video information is with respect to a peripheral situation.

16. A video processing method implemented on a computer system, the method comprising:
receiving video information from at least one of a plurality of external video imaging apparatuses;
obtaining imaging position information, imaging angle information, and an imaging method associated with the video information;
measuring a present position;
determining a mapping format of the video information to a display screen region, the mapping format based on the imaging position information, imaging angle information, imaging method associated with the video information, and the present position;
converting the received video information for display based on the mapping format; and
outputting the converted video to a display device.

17. The video processing method of claim 16, wherein the computer system is located on a mobile device, wherein the present position is of the mobile device, and wherein the position measuring module is further configured to determine the traveling direction of the mobile device.
